(19) United States
(12) Patent Application Publication
(10) Pub. No.: US 2014/0163841 A1
(43) Pub. Date: Jun. 12, 2014

(54) ENGINE DIAGNOSTIC SYSTEM AND METHOD

(71) Applicant: CATERPILLAR INC., Peoria, IL (US)

(72) Inventor: Pranav Sane, Peoria, IL (US)

(73) Assignee: Caterpillar Inc., Peoria, IL (US)

(21) Appl. No.: 13/710,829

(22) Filed: Dec. 11, 2012

(51) Int. Cl. F02D 41/30

(52) U.S. Cl. CPC F02D 41/30
USPC 701/104

(57) ABSTRACT

A diagnostic method for a reciprocating internal combustion engine with multiple cylinders includes determining a first exhaust gas percentage in an exhaust stream of the engine while cutting a fuel supply to a first cylinder of the multiple cylinders and fueling the remainder of the multiple cylinders. The method also includes determining a second exhaust gas percentage in the exhaust stream while cutting a fuel supply to a second cylinder of the multiple cylinders and fueling the remainder of the multiple cylinders, and determining a diagnostic condition of the engine as a function of the first exhaust gas percentage and the second exhaust gas percentage.

### TECHNICAL FIELD

The present disclosure relates generally to reciprocating internal combustion engine diagnostic methods. Specifically, an embodiment of the present invention relates to a reciprocating internal combustion engine diagnostic method including cutting the fuel supply to a cylinder of the engine.

### BACKGROUND

During operation engines may need periodic evaluation to determine proper operation. Engine diagnostic tests may be used to determine overall health of the engine. These diagnostic tests may indicate potential engine problems for the engine, but further tests may be needed to isolate the problem to a particular cylinder within an engine.

U.S. Pat. No. 5,605,132 to Toshio Hori et al. discloses an engine control method and apparatus wherein a combustion state in each cylinder of an internal combustion engine is detected based on the fluctuation of the rotating angular speed of an engine. A correction control is performed to make the combustion states in each of the cylinders uniform, followed by the base value for the purpose of correction control is obtained when the fluctuation in the rotating angular speed is small.

### SUMMARY

In one aspect, a diagnostic method for a reciprocating internal combustion engine with multiple cylinders includes determining a first exhaust gas percentage in an exhaust stream of the engine while cutting a fuel supply to a first cylinder of the multiple cylinders and fueling the remainder of the multiple cylinders. The method also includes determining a second exhaust gas percentage in the exhaust stream while cutting a fuel supply to a second cylinder of the multiple cylinders and fueling the remainder of the multiple cylinders, and determining a diagnostic condition of the engine as a function of the first exhaust gas percentage and the second exhaust gas percentage.

In another aspect, a diagnostic method for a reciprocating internal combustion engine with multiple cylinders includes sequentially cutting the fuel to each of the multiple cylinders while continuing to fuel the other multiple cylinders, and determining a percentage of an exhaust gas in an exhaust stream of the engine while the fuel is cut to each of the cylinders. The method also includes determining a diagnostic condition of the engine as a function of the percentage of exhaust gas in the exhaust stream while the fuel was cut to each of the cylinders.

In another aspect, a diagnostic system for a reciprocating internal combustion engine includes a first cylinder, a second cylinder, a first fueling device, a second fueling device, an exhaust gas sensor, and a controller. The first fueling device is configured to selectively deliver fuel to the first cylinder as a function of a first fueling signal. The second fueling device is configured to selectively deliver fuel to the second cylinder as a function of a second fueling signal. The exhaust gas sensor is configured to generate an exhaust gas signal indicative of the percentage of an exhaust gas in an exhaust stream of the engine. The controller is configured to generate the first fueling signal during a first time period to cut fuel to the first cylinder; generate the second fueling signal during a second time period to cut fuel to the second cylinder; and to generate an engine diagnostic signal as a function of at least one exhaust gas signal during the first time period, and at least one exhaust gas signal during the second time period.

### BRIEF DESCRIPTION OF THE DRAWINGS

FIG. 1 schematically depicts an exemplary embodiment of a reciprocating internal combustion engine diagnostic system.

FIG. 2 depicts a flow chart of an exemplary diagnostic method for a reciprocating internal combustion engine.

### DETAILED DESCRIPTION

Reference will now be made in detail to specific embodiments or features, examples of which are illustrated in the accompanying drawings. Generally, corresponding or similar reference numbers will be used, when possible, throughout the drawings to refer to the same or corresponding parts.

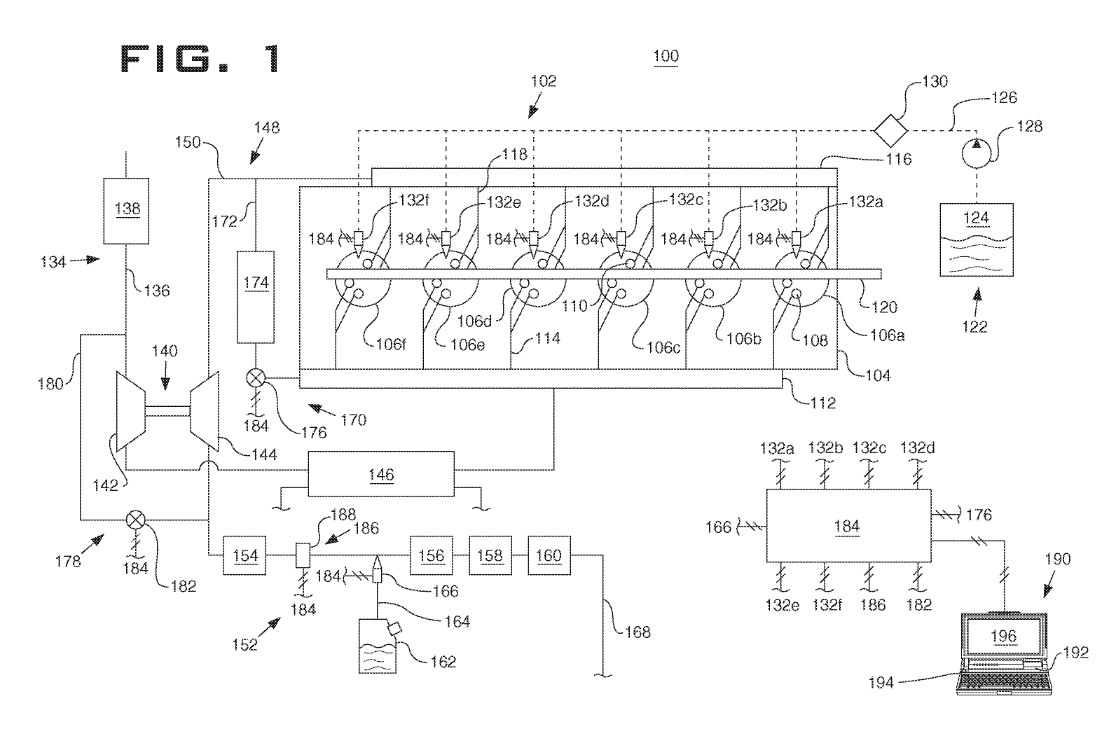

Referring now to FIG. 1, there is illustrated a block diagram representing an exemplary engine diagnostic system 100 for a reciprocating internal combustion engine 102. In one embodiment, the engine 102 includes a diesel engine that combusts a mixture of air and diesel fuel. In alternative embodiments the engine 102 may include a natural gas engine, a gasoline engine, or any multiple cylinder reciprocating internal combustion engine known in the art, in which fueling to individual cylinders 106 is controllable. The illustrated engine 102 includes an engine block 104 in which a plurality of cylinders 106 are disposed. Although six cylinders 106 are shown in an inline configuration, in other embodiments fewer or more cylinders 106 may be included or another configuration such as a V-configuration may be employed. The engine diagnostic system 100 can be utilized in any suitable application including mobile applications such as motor vehicles, work machines, locomotives or marine engines, and in stationary applications such as electrical power generators.

Each cylinder 106 includes one or more intake valves 108, to supply air that is combusted with the fuel in the cylinder 106. A hollow runner or intake manifold 112 can be formed in or attached to the engine block 104 such that it extends over or proximate to each of the cylinders 106. The intake manifold 112 can communicate with an intake air system 134 that directs air to the internal combustion engine 102. Fluid communication between the intake manifold 112 and the cylinders 106 can be established by a plurality of intake runners 114 extending from the intake manifold 112. The intake valves 108 can open and close to selectively introduce the intake air from the intake manifold 112 to the cylinder 106. While the illustrated embodiment depicts the intake valves 108 at the top of the cylinder 106, in other embodiments the intake valves 108 may be placed at other locations such as through a sidewall of the cylinder 106.

To direct exhaust gas from the cylinders 106 after combustion events, each cylinder 106 includes one or more exhaust valves 110. An exhaust manifold 116 communicating with an exhaust system 148 may also be disposed in or proximate to the engine block 104. The exhaust manifold 116 can receive exhaust gasses by selective opening and closing of the one or more exhaust valves 110 associated with each cylinder 106. The exhaust manifold 116 can communicate with the cylinders 106 through exhaust runners 118 extending from the exhaust manifold 116.

To actuate the intake valves 108 and the exhaust valves 110, the illustrated embodiment depicts an overhead camshaft 120 that is disposed over the engine block 104 and operatively engages the intake and exhaust valves 108, 110. As will be familiar to those of skill in the art, the camshaft 120 can include a plurality of eccentric lobes disposed along its length that, as the camshaft 120 rotates, cause the intake and exhaust valves 108, 110 to displace or move up and down in an alternating manner with respect to the cylinders 106. Movement of the intake and exhaust valves 108, 110 can seal and unseal ports leading into the cylinder 106. The placement or configuration of the lobes along the camshaft 120 controls or determines the gas flow through the internal combustion engine 102. As is known in the art, other methods exist for implementing valve 108, 110 and/or intake air and exhaust timing such as electronic, electrical and/or hydraulic actuators acting on the individual valve stems and the like. In some two stroke combustion engines, the intake valves may be replaced with a port which is opened and closed by the moving of a piston (not shown) within the cylinder 106.

To supply the fuel that the engine 102 burns during the combustion process, a fuel system 122 is operatively associated with the diagnostic engine system 100. The fuel system 122 includes a fuel reservoir 124 that can accommodate a hydrocarbon-based fuel such as liquid diesel fuel. Although only one fuel reservoir is depicted in the illustrated embodiment, it will be appreciated that in other embodiments additional reservoirs may be included that accommodate the same or different types of fuels that the combustion process may also burn. Because the fuel reservoir 124 may be situated in a remote location with respect to the engine 102, a fuel line 126 can be disposed through the diagnostic engine system 100 to direct fuel from the fuel reservoir 124 to the engine 102. To pressurize the fuel and force it through the fuel line 124, a fuel pump 128 can be disposed in the fuel line. An optional fuel conditioner 130 may also be disposed in the fuel line 126 to filter the fuel or otherwise condition the fuel by, for example, introducing additives to the fuel, heating the fuel, removing water and the like.

To introduce the fuel to the cylinders 106, the fuel line 126 fluidly connects the fuel reservoir 124 with multiple fuel injectors 132. At least one fuel injector 132 is associated with each cylinder 106. In the illustrated embodiment, one fuel injector 132 is associated with each cylinder 106, but in other embodiments a different number of injectors 132 might be used. Additionally, while the illustrated embodiment depicts the fuel line 126 terminating at the fuel injectors 132, the fuel line 126 may establish a fuel loop that continuously circulates fuel through the plurality of injectors 132 and, optionally, delivers unused fuel back to the fuel reservoir 124. Alternatively, the fuel line 126 may include a fuel collector volume or rail (not shown), which supplies pressurized fuel to the fuel injectors 132. The fuel injectors 132 can be electrically actuated devices that selectively introduce a measured or predetermined quantity of fuel to each combustion chamber 108. In other embodiments, introduction methods other than fuel injectors 132, such as a carburetor or the like, can be utilized.

To assist in directing the intake air into the internal combustion engine 102, the engine diagnostic system 100 can include a turbocharger 140. The turbocharger 140 includes a compressor 142 disposed in the intake air system 134 that compresses intake air drawn from the atmosphere and directs the compressed air to the intake manifold 112. To power the compressor 142, a turbine 144 can be disposed in the exhaust system 148 and can receive pressurized exhaust gasses from the exhaust manifold 116. The pressurized exhaust gasses directed through the turbine 144 can rotate a turbine wheel having a series of blades thereon, which powers a shaft that causes a compressor wheel to rotate within the compressor 142 housing. In the illustrated embodiment, one turbine 144 drives one compressor 142. In alternative embodiments a different number of turbines 144 may drive a different number of compressors 142. Although a single turbocharger 140 is shown, more than one such device connected in series and/or in parallel with another turbocharger 140 can be used. Other air compression methods known in the art, such as for example, other types of superchargers may also be used to compress the intake air.

The intake air system 134 can provide air to the engine 102. An air cleaner 138 to filter debris from intake air drawn from the atmosphere can be disposed on an air intake line 136 upstream of the compressor 142. In the illustrated embodiment, the air intake line 136 fluidly connects the intake manifold 112 with the atmosphere through elements of the air intake system 134. In some embodiments, to assist in controlling or governing the amount of air drawn into the engine diagnostic system 100, an adjustable governor or intake throttle (not shown) can be disposed along the intake line 136 to selectively fluidly connect the intake manifold 112 with the atmosphere through elements of the air intake system 134. Because the intake air may become heated during compression, an intercooler 146 such as an air-to-air heat exchanger can be disposed along the intake line 136 between the compressor 142 and the intake manifold 112 to cool the compressed air.

To direct exhaust gases from the engine 102 combustion process, the engine diagnostic system 100 includes an exhaust system 148. To reduce emissions generated by the combustion process, by treating exhaust gasses before they are discharged to the atmosphere, the exhaust system 148 includes aftertreatment devices 152 fluidly connected to the exhaust manifold 116 through an exhaust conduit 150. Aftertreatment devices 152 can include a diesel oxidation catalyst (DOC) 154, a diesel particulate filter (DPF) 156, a selective catalytic reduction (SCR) catalyst 158, and an ammonia oxidation catalyst (AMOX) 160. In other embodiments aftertreatment devices 152 may include other devices to reduce emissions as are known in the art. One or more of the aftertreatment devices 152 may include a catalyst which requires a reductant be injected into the exhaust gases upstream of the catalyst to be effective. For example, the SCR Catalyst 156 may require a urea solution to be injected into the exhaust gasses. The reductant may be stored in a reductant tank 162, supplied to the exhaust system 148 through a reductant line 164, and injected into the exhaust gases with reductant injector 166. To reduce noise emissions the exhaust system 148 may further include sound suppression devices (not shown). An exhaust gas sensor 186 configured to generate an exhaust gas signal indicative of a percentage of a particular exhaust gas in the exhaust gasses can be disposed in the exhaust conduit 150. Illustrated is a nitrous oxides (NO_{X}) sensor 188 configured to generate the exhaust gas signal indicative of a percentage of NO_{X} in the exhaust gasses. In other embodiment the exhaust gas sensor 186 may be configured to produce the exhaust gas signal indicative of the percentage of other gasses in the exhaust. In some embodiments, the exhaust gas signal may be used in controlling the amount of reductant to be injected into the exhaust gas conduit 150. In other embodiments, the exhaust gas signal may be used in controlling combustion in the cylinders 106, or in any other engine 102 control methods known in the art. The engine exhaust gases can be connected to the atmosphere through an exhaust outlet conduit 168.

To reduce emissions and assist adjusted control over the combustion process, the engine system 100 can mix the intake air with a portion of the exhaust gasses drawn from the exhaust system 148 through a system or process called exhaust gas recirculation (EGR). The EGR system introduces exhaust gas into the intake air conduit 136 and/or intake air manifold 112. The exhaust gas may mix with the intake air and may then be introduced into the cylinder 106 through intake valve 108. In one aspect, addition of exhaust gasses to the intake air displaces the relative amount of oxygen in the cylinders 106 during combustion that results in a lower combustion temperature and reduces the generation of NO_{X}. Two exemplary EGR systems 170, 178 are shown associated with the engine diagnostic system 100 in FIG. 1, but it should be appreciated that these illustrations are exemplary and that either one, both, neither, or another EGR system known in the art can be used on the engine diagnostic system 100. It is contemplated that selection of an EGR system of a particular type may depend on the particular requirements of each engine 102 application.

In the first embodiment, a high-pressure EGR system 170 operates to direct high-pressure exhaust gasses to the intake manifold 112. The high-pressure EGR system 170 includes a high-pressure EGR line 172 that communicates with the exhaust line 150 downstream of the exhaust manifold 116 and upstream of the turbine 144 to receive the high-pressure exhaust gasses being expelled from the cylinders 106. The system is thus referred to as a high-pressure EGR system 170 because the exhaust gasses received have yet to depressurize through turbine 144 or other aftertreatment devices 152. The high-pressure EGR line 172 is also in fluid communication with the intake manifold 114. To control the amount or quantity of the exhaust gasses combined with the intake air, the high-pressure EGR system 170 can include a high pressure EGR valve 176 disposed along the high-pressure EGR line 150. Hence, the ratio of exhaust gasses mixed with intake air can be varied during operation by adjustment of the high pressure EGR valve 176. Because the exhaust gasses may be at a sufficiently high temperature that may affect the combustion process, the high-pressure EGR system 170 can also include an EGR cooler 174 disposed along the high-pressure EGR line 172 to cool the exhaust gasses.

In the second embodiment, a low-pressure EGR system 178 directs low-pressure exhaust gasses to the intake line 136 before it reaches the intake manifold 112. The low-pressure EGR system 178 includes a low-pressure EGR line 180 that communicates with the exhaust line 150 downstream of the turbine 144 so that it receives low-pressure exhaust gasses that have depressurized through the turbine 144, and delivers the exhaust gasses upstream of the compressor 142 so the exhaust gasses can mix and be compressed with the incoming air. The system 178 is thus referred to as a low-pressure EGR system 178 because it operates using depressurized exhaust gasses. To control the quantity of exhaust gasses re-circulated, the low-pressure EGR line 180 can also include a low pressure EGR valve 182.

To coordinate and control the various systems and components associated with the engine diagnostic system 100, the system 100 can include an electronic or computerized control unit, module, or controller 184. The controller 184 is adapted to monitor various operating parameters and to responsively regulate various variables and functions affecting engine 102 operation. The controller 184 can include a microprocessor, an application specific integrated circuit (ASIC), or other appropriate circuitry and can have memory or other data storage capabilities. The controller 184 can include functions, steps, routines, data tables, data maps, charts, and the like, saved in, and executable from, read only memory, or another electronically accessible storage medium, to control the engine diagnostic system 100. Although in FIG. 1, the controller 184 is illustrated as a single, discrete unit, in other embodiments, the controller 184 and its functions may be distributed among a plurality of distinct and separate components. The single unit or multiple component controller 184 may be located on-board, and/or in a remote location. To receive operating parameters and send control commands or instructions, the controller 184 can be operatively associated with and can communicate with various sensors and controls on the engine diagnostic system 100. Communication between the controller 184 and the sensors can be established by sending and receiving digital or analog signals across electronic communication lines or communication busses. In some embodiments the communication between the controller 184 and the sensors may be by radio, satellite, and/or telecommunication channels.

To control the combustion process and/or to run diagnostic tests on the engine 102, the controller 184 can communicate with injector controls of fuel injectors 132 operatively associated with the cylinders. The injector controls can selectively activate or deactivate all, any combination of, or any one of the fuel injectors 132 to determine the timing of introduction, and the quantity of fuel, introduced by each fuel injector 132.

The controller 184 can also be operatively associated with either or both of the high-pressure EGR system 170 and the low-pressure EGR system 178. For example, the controller 184 can be communicatively linked to a high-pressure EGR control associated with the high pressure EGR valve 176 disposed in the high-pressure EGR line 172. Similarly, the controller 184 can also be communicatively linked to a low-pressure EGR control associated with the low pressure EGR valve 182 in the low-pressure EGR line 180. The controller 184 can thereby adjust the amount of exhaust gasses and the ratio of intake air/exhaust gasses introduced to the combustion process.

The controller 184 can be communicatively linked with the exhaust gas sensor 186 to receive the exhaust gas signal. The controller 184 may control one or more functions associated with the aftertreatment devices 152 as a function of the exhaust gas signal. For example, when the exhaust gas sensor 186 includes the NO_{X} sensor 188, the controller 184 may control the amount of reductant injected into the exhaust gas conduit 150, by controlling the timing of reductant injections by the reductant injector 166. The controller 184 can also run diagnostic tests on engine 102 through controlling the injection of fuel through fuel injectors 132 while monitoring the exhaust gas signal.

The controller 184 may monitor other engine diagnostic system 100 parameters and control other engine diagnostic system 100 functions as is known in the art.

The engine diagnostic system 100 can include a user interface 190 for allowing an operator to run and view the results of diagnostic tests. In the illustrated embodiment the user interface includes a service tool 192 shown in the form of a laptop computer with service software. The service tool 192 can include an input device 194 (shown as a keyboard) for commanding a diagnostic test to run, and a display 196 (shown as a laptop computer screen) for receiving the results of the diagnostic test. The user interface 190 can be configured to communicatively connect to the controller 184 through a cable or other communication hardwire link; through wireless means such as radio frequency, cellular, or satellite technologies; or through any other communicative link known in the art. The service tool 192 may selectively be connected with the controller through a cable or other communicative link to perform diagnostic tests on the engine 102.

### INDUSTRIAL APPLICABILITY

Parts and/or assemblies located in the combustion cylinders 106 of the engine 102, such as, but not limited to, liners, pistons, and piston rings may wear or be subject to other deterioration which may eventually lead to engine 102 failures or problems. In some engine 102 operating conditions, during normal operation, all of multiple cylinders 132 may exhaust an essentially equal or known proportion of an exhaust gas. For example, in one embodiment, all of the multiple cylinders 106 may exhaust an essentially equal proportion of NO_{X} when the engine 102 is operating in a low speed range at a low load.

Depending on engine 102 configuration and operating parameters the operating conditions during which multiple cylinders 106 exhaust an essentially equal or known proportion of an exhaust gas may vary from engine to engine. One skilled in the art will be able to determine a predetermined cylinder exhaust distribution range in which multiple cylinders 106 exhaust an essentially equal or known proportion of an exhaust gas during engine 102 operation during those operating conditions.

When one of the cylinders 106, or parts and/or assemblies in the cylinder 106, experience wear, damage, or are incorrectly assembled, such one of the cylinders 106 may exhaust different proportions of exhaust gasses than other cylinders 106, or different proportions than expected in relation to the other cylinders 106, while the engine is operating in the predetermined cylinder exhaust distribution range. It may be possible to identify when a cylinder 106 has unacceptable wear or damage, and/or is misassembled, before it would otherwise be known and cause additional damage to or failure of the engine 102 by: (a) running the engine 102 in the predetermined cylinder exhaust distribution range; (b) cutting fuel to each cylinder 106 in sequence while fueling the other cylinders 106; and (c) measuring the percentage of an exhaust gas from the engine 102. When the engine 102 is experiencing an operating problem, it may also be possible to identify which cylinder 106 is causing the operating problem to simplify servicing the engine 102.

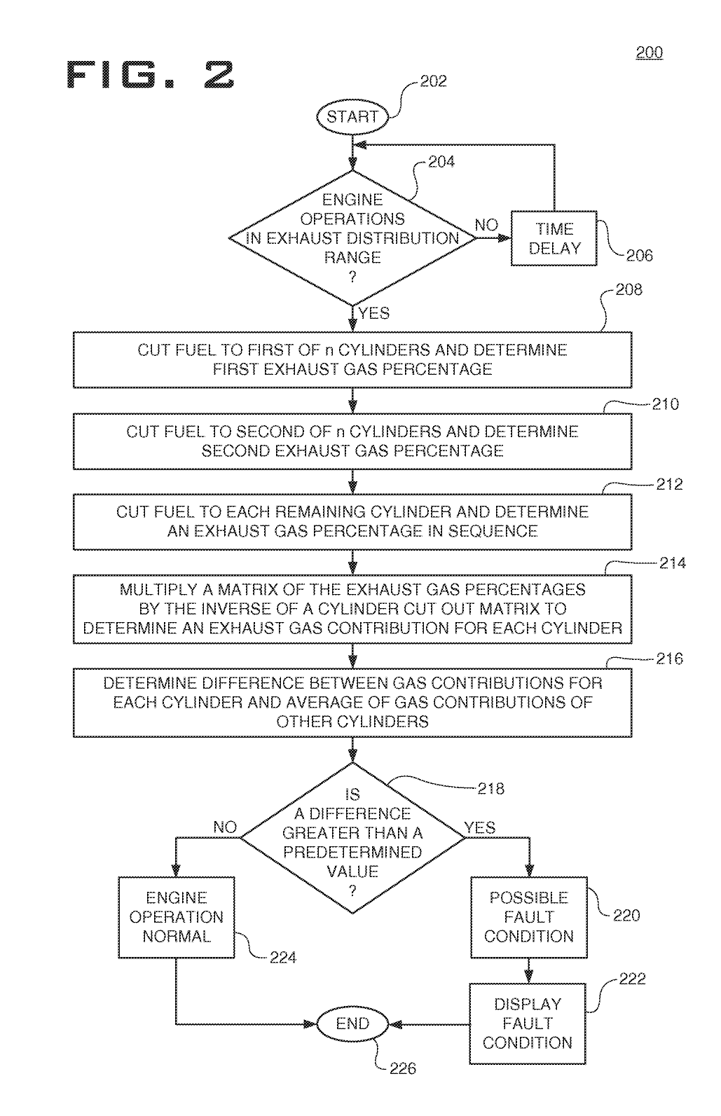

Referring now to FIG. 2, an exemplary diagnostic method 200 for a reciprocating internal combustion engine 102 with multiple cylinders 106 is depicted. In one embodiment, the diagnostic method 200 includes determining a first exhaust gas percentage in an exhaust stream of the engine 102 while cutting a fuel supply to a first cylinder 106a of the multiple cylinders 106 and fueling the remainder of the multiple cylinders 106; determining a second exhaust gas percentage in the exhaust stream while cutting a fuel supply to a second cylinder 106b of the multiple cylinders 106 and fueling the remainder of the multiple cylinders 106; and determining a diagnostic condition of the engine 102 as a function of the first exhaust gas percentage and the second exhaust gas percentage.

Another embodiment of method 200 includes sequentially cutting the fuel to each of the multiple cylinders 106 while continuing to fuel the other multiple cylinders 106, and determining a percentage of an exhaust gas in an exhaust stream of the engine 102 while the fuel is cut to each of the cylinders 106; and determining a diagnostic condition of the engine 102 as a function of the percentage of exhaust gas in the exhaust stream while the fuel was cut to each of the cylinders 106.

The method 200 starts at step 202. In some embodiments, the controller 184 may receive a signal from a service tool 192 or other user interface 190 to begin the method 200. For example, a service technician may connect the service tool 192 to the controller 184 and command the beginning of the method 200. In another example, at the end of an assembly line, a technician may connect a user interface 190 to the controller 184 and command the start of the method 200. In one embodiment, the controller 184 may include a memory device (not shown) with code that commands the start of the method 200 at periodic times or operating conditions. The method proceeds to step 204.

In step 204, the controller 184 determines whether the engine 102 is running in a predetermined exhaust distribution range. Depending on the configuration of engine 102 and associated systems, the cylinders 106 may exhaust different proportions of different exhaust gasses at different operating conditions. For example, in some operating conditions, the distribution of EGR gasses being delivered to the cylinders 106 through the intake valves 108 may vary greatly, and may cause the characteristics of gasses exhausted from the cylinders 106 through the exhaust valves 110 to vary greatly. In other configurations, exhaust gas pressure exerted on different cylinders 106 may vary and cause characteristics of gasses exhausted from the cylinders 106 to vary. For the purpose of the method, a predetermined exhaust gas distribution operating range is defined where the percentage of exhaust gas exhausted from each cylinder 106 is expected to be essentially the same when the engine 102 is operating correctly. For purposes of this application, essentially the same is defined as having a standard deviation of less than five percent. Alternatively, the predetermined exhaust gas distribution operation range may be defined where proportions of the exhaust gas exhausted from each cylinder 106 in relation to other cylinders 106 when the engine 102 is operating correctly is known.

In step 202, the controller 184 may check the value of parameters received through sensors and/or other means and determine whether the engine 102 is operating in the predetermined exhaust gas distribution range. In some embodiments, the controller 184 may receive a signal from a service tool 192 or other user interface 190 to control the engine 102 to run in the predetermined exhaust gas distribution range. If the controller 184 determines that the engine 102 is running in the predetermined exhaust gas distribution range, the method 200 proceeds to step 208. If the controller 184 determines that the engine 102 is not running in the predetermined exhaust gas distribution range, the method 200 proceeds to step 206.

In step 206 there is a time delay. In some embodiments, the time delay is a set time period and the method 200 may run a continuous loop. In other embodiments where the controller 184 includes the memory device with code instructing the method to run at periodic times or at certain operating conditions, the time delay may simply be the time programmed into the memory device or the time until the set operating conditions occur. When the time period expires, the method moves from step 206 to step 204.

In step 208 the controller 184 cuts fueling to a first cylinder 106 while fueling the other cylinders 106 normally. For example, the controller 184 may send signals to fuel injector 132a not to provide fuel to cylinder 106a, while sending normal fueling signals to fuel injectors 132b, 132c, 132d, 132e, and 132f, such that cylinders 106b, 106c, 106d, 106e, and 106f receive normal amounts of fuel. While cutting the fuel to cylinder 106a, the controller 184 may save one or more exhaust gas signals from exhaust gas sensor 186. The first exhaust gas percentage may be calculated as a function of the one or more exhaust gas signals. For example, the first exhaust gas percentage may be an average of the percentage of an exhaust gas as indicated by the exhaust gas signals during the time that the fuel is cut in cylinder 106a. In one embodiment where exhaust gas sensor 186 includes NO_{X} sensor 188, the controller 184 may calculate and save a first NO_{X} gas percentage as a function of NO_{X} gas signals from the NO_{X} sensor while the fuel is cut to the first cylinder 106a. The method 200 proceeds to step 210.

In step 210 the controller 184 cuts fueling to a second cylinder 106 while fueling the other cylinders 106 normally. For example, the controller 184 may send signals to fuel injector 132b not to provide fuel to cylinder 106b, while sending normal fueling signals to fuel injectors 132a, 132c, 132d, 132e, and 132f, such that cylinders 106a, 106c, 106d, 106e, and 106f receive normal amounts of fuel. While cutting the fuel to cylinder 106b, the controller 184 may save one or more exhaust gas signals from exhaust gas sensor 186. The second exhaust gas percentage may be calculated as a function of the one or more exhaust gas signals. For example, the second exhaust gas percentage may be an average of the percentage of an exhaust gas as indicated by the exhaust gas signals during the time that the fuel is cut in cylinder 106b. In one embodiment where exhaust gas sensor 186 includes NO_{X} sensor 188, the controller 184 may calculate and save a second NO_{X} gas percentage as a function of NO_{X} gas signals from the NO_{X} sensor while the fuel is cut to the second cylinder 106b. The method 200 proceeds to step 212.

In step 212, the controller 184 cuts fueling to each remaining cylinder 106 while fueling the other cylinders 106 normally in sequence. For example, in the engine 102 depicted in FIG. 1, with six cylinders 106, the controller 184 may send signals to fuel injectors 132c, 132d, 132e, and 132f, in sequence not to provide fuel to the associated cylinder 106, while sending normal fueling signals to the other fuel injectors 132 such that the other cylinders 106 receive normal amounts of fuel. While cutting the fuel to cylinders 106c, 106d, 106e, and 106f, the controller 184 may save the exhaust gas signals from exhaust gas sensor 186 and calculate an associated exhaust gas percentage. For example, while cutting fuel to injector 132c the controller 184 may save and calculate a third exhaust gas percentage, while cutting fuel to injector 132d the controller 184 may save and calculate a fourth exhaust gas percentage, while cutting fuel to injector 132e the controller 184 may save and calculate a fifth exhaust gas percentage, and while cutting fuel to injector 132f the controller 184 may save and calculate a sixth exhaust gas percentage. In embodiments where exhaust gas sensor 186 includes NO_{X} sensor 188, the controller 184 may calculate and save NO_{X} gas percentages from the NO_{X} gas signals from the NO_{X} sensor 188. For an engine with n cylinders, the controller 184 saves n exhaust gas percentages. Each exhaust gas percentage is associated with one of the n cylinders 106 not being fueled. In steps 208, 210, and 212, the fueling may be cut to a cylinder 106 for a predetermined time period and the exhaust gas percentage may be an average of the exhaust gas signals the controller 184 receives during that predetermined time period. The method 200 proceeds to step 214.

In step 214, the controller 184 multiplies a matrix of exhaust gas percentages by the inverse of a cylinder cut-out matrix to determine an exhaust gas contribution matrix which identifies the gas contribution for each cylinder 106. The matrix of exhaust gas percentages is a matrix with one column and the same number of rows as the engine 102 has cylinders 106. If each cylinder 106 has a number n associated with it, the value in each row n of the column, represents an exhaust gas percentage value for when the fuel was cut to the n^{th} cylinder 106.

A cylinder cut-out matrix is a matrix with as many rows and columns, as the engine 102 has cylinders 106. If the engine 102 has n cylinders 106, the cylinder cut-out matrix has n rows, and n columns. Each row n represents when the controller 184 cuts the fueling to the n^{th} cylinder 106. The columns represent the number n associated with each cylinder 106. A value of “1” in the matrix means that the cylinder 106 is fueled. The number “0” in the matrix means that the cylinder 106 was not fueled. For example, if the engine 102 has six cylinders 106, the cylinder cut-out matrix has six rows and six columns. Each cylinder 106 is assigned a number from one to six. If the controller 184 cuts the fuel to the cylinder 106 associated with “1” first and fuels the other cylinders, the first row of the matrix reads “0 1 1 1 1 1”. If the controller 184 cuts the fuel to the cylinder 106 associated with “2” second and fuels the other cylinders, the second row of the matrix reads “1 0 1 1 1 1”. If the controller 184 cuts the fuel to the cylinder 106 associated with “3” third and fuels the other cylinders, the third row of the matrix reads “1 1 0 1 1 1”. If the controller 184 cuts the fuel to the cylinder 106 associated with “4” fourth and fuels the other cylinders, the fourth row of the matrix reads “1 1 1 0 1 1”. If the controller 184 cuts the fuel to the cylinder 106 associated with “5” fifth and fuels the other cylinders, the fifth row of the matrix reads “1 1 1 1 0 1”. If the controller 184 cuts the fuel to the cylinder 106 associated with “6” sixth and fuels the other cylinders, the sixth row of the matrix reads “1 1 1 1 1 0”.

The exhaust gas contribution matrix is a matrix with one column and the same number of rows as the engine 102 has cylinders 106. If each cylinder 106 has a number n associated with it, the value in each row n of the column, represents the exhaust gas contribution of the n^{th} cylinder 106.

Equation 1, below illustrates the relationship between an exemplary cylinder cut-out matrix, exhaust gas contribution matrix, and exhaust gas percentage matrix for an engine 102 with n cylinders 106. The first matrix is the cylinder cut-out matrix. The second matrix is the exhaust gas contribution matrix where xₙ represents each cylinder, n's, 106 exhaust gas contribution. The third matrix is the exhaust gas percentage matrix where Cₙ represents the exhaust gas percentage when the n^{th} cylinder 106 was not fueled.

$$\begin{matrix}\begin{matrix}\begin{matrix}\begin{matrix}\begin{matrix}1 \\ 2\end{matrix} \\ 3\end{matrix} \\ …\end{matrix} \\ …\end{matrix} \\ n\end{matrix} {( \begin{matrix}0 & 1 & 1 & 1 & … & 1 \\ 1 & 0 & 1 & 1 & … & 1 \\ 1 & 1 & 0 & 1 & … & 1 \\ … & … & … & … & … & … \\ … & … & … & … & … & … \\ 1 & 1 & 1 & 1 & … & 0\end{matrix} )}^{\begin{matrix} 1 & 2 & 3 & … & … & n\end{matrix}} \times ( \begin{matrix}x 1 \\ x 2 \\ x 3 \\ … \\ … \\ xn\end{matrix} ) = ( \begin{matrix}C 1 \\ C 2 \\ C 3 \\ … \\ … \\ Cn\end{matrix} ) \qquad Equation 1$$

For an engine 102 including six cylinders 106, as illustrated in FIG. 1, Equation 1 can be rewritten as Equation 2 as shown below.

$${( \begin{matrix}0 & 1 & 1 & 1 & 1 & 1 \\ 1 & 0 & 1 & 1 & 1 & 1 \\ 1 & 1 & 0 & 1 & 1 & 1 \\ 1 & 1 & 1 & 0 & 1 & 1 \\ 1 & 1 & 1 & 1 & 0 & 1 \\ 1 & 1 & 1 & 1 & 1 & 0\end{matrix} )}^{\begin{matrix}1 & 2 & 3 & 4 & 5 & 6\end{matrix}} \times ( \begin{matrix}x 1 \\ x 2 \\ x 3 \\ x 4 \\ x 5 \\ x 6\end{matrix} ) = ( \begin{matrix}C 1 \\ C 2 \\ C 3 \\ C 4 \\ C 5 \\ C 6\end{matrix} ) \qquad Equation 2$$

After steps 208, 210, and 212 are performed, the controller 184 may form the exhaust gas percentage matrix as a function of the values received from the exhaust gas sensor 186. An inverse of the cylinder cut-out matrix may be stored in a memory device for use by the controller 184. Calculating the inverse of a matrix is well known in the art. By multiplying the inverse of the cut-out matrix by the exhaust gas percentage matrix, as shown in Equation 3, below, for a six cylinder 106 engine 102, the controller 184 may form the exhaust gas contribution matrix. In Equation 3, the first matrix is the exhaust gas contribution matrix where xₙ represents the contribution of the n^{th} cylinder, the second matrix is the exhaust gas percentage matrix where Cₙ is the exhaust gas percentage value the controller 184 stored while cutting fuel to the n^{th} cylinder, and the third matrix is the inverse of a cylinder cut-out matrix for a six cylinder 106 engine 102.

$$( \begin{matrix}x 1 \\ x 2 \\ x 3 \\ x 4 \\ x 5 \\ x 6\end{matrix} ) = ( \begin{matrix}C 1 \\ C 2 \\ C 3 \\ C 4 \\ C 5 \\ C 6\end{matrix} ) \times ( \begin{matrix}- 0.8 & 0.2 & 0.2 & 0.2 & 0.2 & 0.2 \\ 0.2 & - 0.8 & 0.2 & 0.2 & 0.2 & 0.2 \\ 0.2 & 0.2 & - 0.8 & 0.2 & 0.2 & 0.2 \\ 0.2 & 0.2 & 0.2 & - 0.8 & 0.2 & 0.2 \\ 0.2 & 0.2 & 0.2 & 0.2 & - 0.8 & 0.2 \\ 0.2 & 0.2 & 0.2 & 0.2 & 0.2 & - 0.8\end{matrix} ) \qquad Equation 3$$

The method 200 proceeds to step 216.

Steps 216 through 224 illustrate exemplary steps to determine a diagnostic condition of the engine 102 as a function of the exhaust contributions xₙ calculated in preceding steps. The diagnostic condition may include that nothing abnormal has been found in engine 102 operation, that something abnormal has been found in engine 102 operation, and/or that something abnormal has been found in the operation of one of the cylinders 106 of engine 102. The diagnostic condition is determined by comparing each exhaust gas contribution xₙ with the other exhaust gas contributions xₙ. If the relationship between an exhaust gas contribution xₙ and the other exhaust gas contributions xₙ is not the expected relationship, this may indicate that there is something abnormal in the operation of the cylinder 106 which produced the exhaust contribution xₙ which has an abnormal relationship with the other exhaust gas contributions xₙ.

For example, in some engines 102, the exhaust gas contribution xₙ may be expected to be essentially equal to the average of the other exhaust gas contributions xₙ. Steps 216 through 226 illustrate an exemplary method of determining a diagnostic condition of the engine 102 as a function of the exhaust contributions xₙ calculated in preceding steps in this exemplary situation. In step 216 the controller 184 may calculate a difference, difference(n), between each exhaust gas contribution xₙ and the average of the other exhaust gas contributions xₙ. The method proceeds to step 218.

In step 218 the controller determines if any difference(n) is greater than a predetermined value. If any of the difference(n)s are greater than the predetermined value, the method 200 proceeds to step 220. If none of the difference(n)s are greater than the predetermined value, the method proceeds to step 224.

In step 220 the controller 184 may determine the diagnostic condition of the engine 102 includes a possible fault condition. The possible fault condition may include identifying the cylinder 106 which may have the fault condition. The controller 184 may generate a signal indicative of the fault condition and may log the fault condition in a memory device. For example, when the controller 184 is programmed to run method 200 at predetermined intervals and/or during predetermined engine 102 conditions, the controller 184 may log the fault in the memory for use with other service and diagnostic routines. The method 200 proceeds to step 222.

In step 222, the controller 184 may communicate with a display 196 such that the display 196 displays a graphic representation of the fault condition. When the user interface 190 includes the service tool 192, the display 196 may be an element of the service tool 192, such as when the service tool 192 includes a laptop computer with service software as depicted in FIG. 1. In other embodiments, the display may be located onboard a machine (not shown) powered by the engine 102, or may be located remotely. The method 200 proceeds to step 226 and ends.

In step 224, when none of the difference(n)s are greater than the predetermined value, the controller 184 may determine the diagnostic condition of the engine 102 includes normal engine operation. In some embodiments, the controller 184 may log and/or display a graphical representation of the engine condition. The method proceeds to step 226 and ends.

It will be appreciated that the foregoing description provides examples of the disclosed system and method. However, it is contemplated that other implementations of the system and/or method may differ in detail from the foregoing examples. All references to the system and/or method or examples thereof are intended to reference the particular example being discussed at that point, and are not intended to imply any limitation as to the scope of the system and/or method more generally. All language of distinction and disparagement with respect to certain features is intended to indicate a lack of preference for those features, but not to exclude such from the scope of the system and/or method entirely unless otherwise indicated.

What is claimed is:

1. A diagnostic method for a reciprocating internal combustion engine with multiple cylinders, comprising:
determining a first exhaust gas percentage in an exhaust stream of the engine while cutting a fuel supply to a first cylinder of the multiple cylinders and fueling the remainder of the multiple cylinders,
determining a second exhaust gas percentage in the exhaust stream while cutting a fuel supply to a second cylinder of the multiple cylinders and fueling the remainder of the multiple cylinders, and
determining a diagnostic condition of the engine as a function of the first exhaust gas percentage and the second exhaust gas percentage.

2. The method of claim 1, wherein the fuel is cut to the first cylinder, and the fuel is cut to the second cylinder, while engine operation is in a predetermined cylinder exhaust distribution range.

3. The method of claim 1, wherein the fuel supply is cut to the first cylinder, and the fuel supply is cut to the second cylinder, for a predetermined time period.

4. The method of claim 3, wherein;
the first exhaust gas percentage is determined as an average of measurements of the percent of the exhaust gas in the engine exhaust stream during the predetermined time period that the fuel supply is cut to the first cylinder, and
the second exhaust gas percentage is determined as an average of measurements of the percent of the exhaust gas in the engine exhaust stream during the predetermined time period that the fuel supply is cut to the second cylinder.

5. The method of claim 1, wherein the exhaust gas includes nitrous oxides (NO_{X}).

6. The method of claim 1, further including;
determining a first cylinder exhaust gas contribution as a function of the first exhaust gas percentage and the second exhaust gas percentage,
determining a second cylinder exhaust gas contribution as a function of the first exhaust gas percentage and the second exhaust gas percentage, and
determining the diagnostic condition of the engine as a function of the first cylinder exhaust gas contribution and the second cylinder exhaust gas contribution.

7. The method of claim 6 further including;
comparing the first cylinder exhaust gas contribution to a baseline first cylinder contribution and determining a first cylinder baseline difference,
comparing the second cylinder exhaust gas contribution to a baseline second cylinder contribution and determining a second cylinder baseline difference, and
determining the diagnostic condition of the engine as a function of the first cylinder baseline difference and the second cylinder baseline difference.

8. The method of claim 7, wherein the diagnostic condition includes a fault condition, when at least one of the first cylinder baseline difference and the second cylinder baseline difference is above a predetermined baseline cylinder difference value.

9. The method of claim 6 further including;
determining a cylinder difference between the first cylinder exhaust gas contribution and the second cylinder exhaust gas contribution, and
determining the diagnostic condition of the engine as a function of the cylinder difference.

10. The method of claim 9, wherein the diagnostic condition includes a fault condition, when the cylinder difference is above a predetermined cylinder difference value.

11. The method of claim 1, further including displaying the diagnostic condition of the engine.

12. The method of claim 1, further including generating a run diagnostic signal as a function of an user input.

13. The method of claim 1, further including;
periodically determining if engine operation is in a predetermined cylinder exhaust distribution range,
determining the first exhaust gas percentage if the engine operation is in the predetermined cylinder exhaust distribution range,
determining the second exhaust gas percentage if the engine operation is in the predetermined cylinder exhaust distribution range,
determining the diagnostic condition of the engine as a function of the first exhaust gas percentage and the second exhaust gas percentage if the engine operation is in the predetermined cylinder exhaust distribution range.

14. The method of claim 1, further including;
determining a first cylinder exhaust gas contribution as a function of the first exhaust gas percentage and the second exhaust gas percentage, and
comparing the first cylinder exhaust gas contribution to a baseline first cylinder contribution and determining a first cylinder baseline difference, and
wherein the diagnostic condition includes a first cylinder fault condition, when the first cylinder baseline difference is above a predetermined baseline cylinder difference value.

15. A diagnostic method for a reciprocating internal combustion engine with multiple cylinders, comprising:
sequentially cutting the fuel to each of the multiple cylinders while continuing to fuel the other multiple cylinders, and determining a percentage of an exhaust gas in an exhaust stream of the engine while the fuel is cut to each of the cylinders, and
determining a diagnostic condition of the engine as a function of the percentage of exhaust gas in the exhaust stream while the fuel was cut to each of the cylinders.

16. A diagnostic system for a reciprocating internal combustion engine, comprising:
a first cylinder,
a second cylinder,
a first fueling device configured to selectively deliver fuel to the first cylinder as a function of a first fueling signal,
a second fueling device configured to selectively deliver fuel to the second cylinder as a function of a second fueling signal,
an exhaust gas sensor configured to generate an exhaust gas signal indicative of the percentage of an exhaust gas in an exhaust stream of the engine,
a controller configured to generate the first fueling signal during a first time period to cut fuel to the first cylinder; generate the second fueling signal during a second time period to cut fuel to the second cylinder; and to generate an engine diagnostic signal as a function of at least one exhaust gas signal during the first time period, and at least one exhaust gas signal during the second time period.

17. The system of claim 16, wherein the exhaust gas sensor includes a nitrous oxide (NO_{X}) sensor.

18. The system of claim 16, further including a user interface communicatively connected to the controller, the user interface including a input device configured to generate a run diagnostic signal, and a diagnostic display configured to display an engine diagnostic condition as a function of the engine diagnostic signal, and
wherein the controller is configured to generate the first fueling signal during a first time period to cut fuel to the first cylinder; and generate the second fueling signal during a second time period to cut fuel to the second cylinder in response to the run diagnostic signal.

19. The system of claim 16, wherein the controller includes a memory device storing a baseline first cylinder contribution, and a baseline second cylinder contribution, and is configured to generate the engine diagnostic signal as a function of the baseline first cylinder contribution, and a baseline second cylinder contribution.

20. The system of claim 16, wherein the controller is configured to periodically generate the first fueling signal during the first time period to cut fuel to the first cylinder; generate the second fueling signal during the second time period to cut fuel to the second cylinder; and to generate the engine diagnostic signal, while engine operation is in a predetermined cylinder exhaust distribution range.
